(19) United States
(12) Patent Application Publication
(10) Pub. No.: US 2017/0103633 A1
(43) Pub. Date: Apr. 13, 2017

(54) ACTIVE THREAT MITIGATION CONTROL SYSTEM

(71) Applicant: OTIS ELEVATOR COMPANY, FARMINGTON, CT (US)

(72) Inventors: Ritesh Khire, South Windsor, CT (US); Arthur Hsu, South Glastonbury, CT (US); Alan Matthew Finn, Hebron, CT (US)

(73) Assignee: Otis Elevator Company, Farmington, CT (US)

(21) Appl. No.: 15/314,784

(22) PCT Filed: May 29, 2015
(86) PCT No.: PCT/US2015/033107

§ 371 Date: Nov. 29, 2016

Related U.S. Application Data
(60) Provisional application No. 62/004,280, filed on May 29, 2014.
(60) Provisional application No. 62/005,438, filed on May 30, 2014.

(51) Int. Cl. G08B 17/10; G08B 17/12; F24F 11/00; A62B 3/00; G05B 15/02; A62C 37/40; G08B 17/02; G08B 25/00

(52) U.S. Cl. CPC G08B 17/10; G08B 17/02; G08B 17/12; G08B 17/125; G08B 25/00; A62B 3/00; G05B 15/02; A62C 37/40; F24F 11/0034; F24F 11/0017; F24F 11/0086; F24F 2011/0095; F24F 2011/0053; F24F 2011/0035; F24F 2011/0036

(57) ABSTRACT

A method and system to mitigate at least one threat associated with a building includes receiving at least one threat parameter of the at least one threat via at least one threat sensor, and actively controlling at least one threat mitigator in response to the at least one threat parameter via a threat controller.

### CROSS REFERENCE TO RELATED APPLICATIONS

This patent application claims priority from U.S. Provisional Patent Application Ser. No. 62/004,280, filed May 29, 2014, and U.S. Provisional Patent Application Ser. No. 62/005,438, filed May 30, 2014, all of which are incorporated herein by reference in their entirety.

### BACKGROUND

The subject matter disclosed herein relates to building equipment and control systems, and to a system and a method for mitigating threats within a building.

Typically, certain building equipment and control systems can be utilized for evacuation and threat management purposes during emergency events. For example, sprinklers, lighting systems, elevators, access control systems, etc. can be utilized to reduce risk to occupants. Advantageously, building equipment and control systems can effectively mitigate current or emerging threats and enhance the safety of building occupants.

Evacuation and threat response plans are often include predetermined building system responses. Building equipment and control systems may provide individual control of building systems, but may not be integrated to provide a comprehensive response in accordance with dynamic threats and occupant behaviour. A system and method that can receive threat parameters and mitigate threats to occupants is desired.

### BRIEF SUMMARY

According to an embodiment, method to mitigate at least one threat associated with a building includes receiving at least one threat parameter of the at least one threat via at least one threat sensor, and actively controlling at least one threat mitigator in response to the at least one threat parameter via a threat controller.

In addition to one or more of the features described above, or as an alternative, further embodiments could include that the at least one threat sensor is selected from a group consisting of a manually activated threat trigger, a smoke detector, a heat detector, a chemical detector, a biological detector, a radiation detector, an acoustic detector, a seismic detector.

In addition to one or more of the features described above, or as an alternative, further embodiments could include that the at least one threat parameter is selected from a group consisting of: a threat type, a threat scope, a threat propagation, and a threat pattern.

In addition to one or more of the features described above, or as an alternative, further embodiments could include that the at least one threat mitigator is selected from a group consisting of: a sprinkling device, a battery discharge device, a fire suppression coating device, an inert gas release device, a suppressant delivery device, a controlled burn device, a robotic device, and a filtration device.

In addition to one or more of the features described above, or as an alternative, further embodiments could include controlling an HVAC system in response to the at least one threat parameter via the threat controller.

In addition to one or more of the features described above, or as an alternative, further embodiments could include providing the at least one threat parameter to at least one first responder.

In addition to one or more of the features described above, or as an alternative, further embodiments could include identifying at least one zone of the building via the threat controller.

In addition to one or more of the features described above, or as an alternative, further embodiments could include identifying at least one refuge zone of the at least one zone via the threat controller.

In addition to one or more of the features described above, or as an alternative, further embodiments could include identifying at least one risk zone of the at least one zone via the threat controller.

In addition to one or more of the features described above, or as an alternative, further embodiments could include receiving at least one occupancy parameter of a plurality of occupants via at least one occupancy sensor, and controlling at least one occupancy actuator in response to the at least one occupancy parameter via the threat controller.

In addition to one or more of the features described above, or as an alternative, further embodiments could include that the at least one occupancy sensor is selected from a group consisting of: a video camera, a stereo camera, a passive infrared motion sensor, a pyroelectric sensor, a radio-frequency identification (RFID) sensor, a radar, a heartbeat sensor, a breathing sensors, a microphone; a LIDAR, a structured light depth sensor, a Time of Flight depth sensor, a switch, a piezoelectric sensor, a fiber optic strain sensor, a vibration sensor, and a micro electromechanical system (MEMS).

In addition to one or more of the features described above, or as an alternative, further embodiments could include that the at least one occupancy parameter is selected from a group consisting of: an occupant count, an occupant location, an occupant flow pattern, an occupant mobility level, and a building layout.

In addition to one or more of the features described above, or as an alternative, further embodiments could include that the at least one occupancy actuator is selected from a group consisting of: a display, a mobile communication device notification, audio announcement device, a mobile platform, and a door access control.

In addition to one or more of the features described above, or as an alternative, further embodiments could include that the at least one occupancy actuator is selected from a group further consisting of an elevator control, escalator or people mover.

According to an embodiment, building control system includes at least one threat sensor to receive at least one threat parameter, and a threat controller to control at least one threat mitigator in response to the at least one the at least one threat parameter.

In addition to one or more of the features described above, or as an alternative, further embodiments could include that the at least one threat sensor is selected from a group consisting of a manual threat trigger, a smoke detector, a heat detector, a chemical sensor, a biological sensor, a radiation sensor, an acoustic sensor, a seismic sensor.

In addition to one or more of the features described above, or as an alternative, further embodiments could include that the at least one threat parameter is selected from a group consisting of: a threat type, a threat scope, a threat propagation, and a threat pattern.

In addition to one or more of the features described above, or as an alternative, further embodiments could include that the at least one threat mitigator is selected from a group consisting of: a sprinkling device, a battery discharge device, a fire suppression coating device, an inert gas release device, a suppressant delivery device, a controlled burn device, a robotic device, and a filtration device.

In addition to one or more of the features described above, or as an alternative, further embodiments could include that the at least one threat mitigator is selected from the group further consisting of an HVAC system.

In addition to one or more of the features described above, or as an alternative, further embodiments could include at least one occupancy sensor to receive at least one occupancy parameter, wherein the threat controller controls at least one threat mitigator in response to the at least threat parameter and the at least one occupancy parameter.

The technical function of the embodiments described above includes controlling at least one threat mitigator in response to the at least one threat parameter via a threat controller.

Other aspects, features, and techniques of the embodiments will become more apparent from the following description taken in conjunction with the drawings.

### BRIEF DESCRIPTION OF THE DRAWINGS

The subject matter is particularly pointed out and distinctly claimed in the claims at the conclusion of the specification. The foregoing and other features, and advantages of the embodiments are apparent from the following detailed description taken in conjunction with the accompanying drawings in which like elements are numbered alike in the FIGURES:

FIG. 1 illustrates a schematic view of an exemplary building control system for use with an embodiment; and

FIG. 2 is a flowchart illustrating a method to mitigate threats associated with a building.

### DETAILED DESCRIPTION

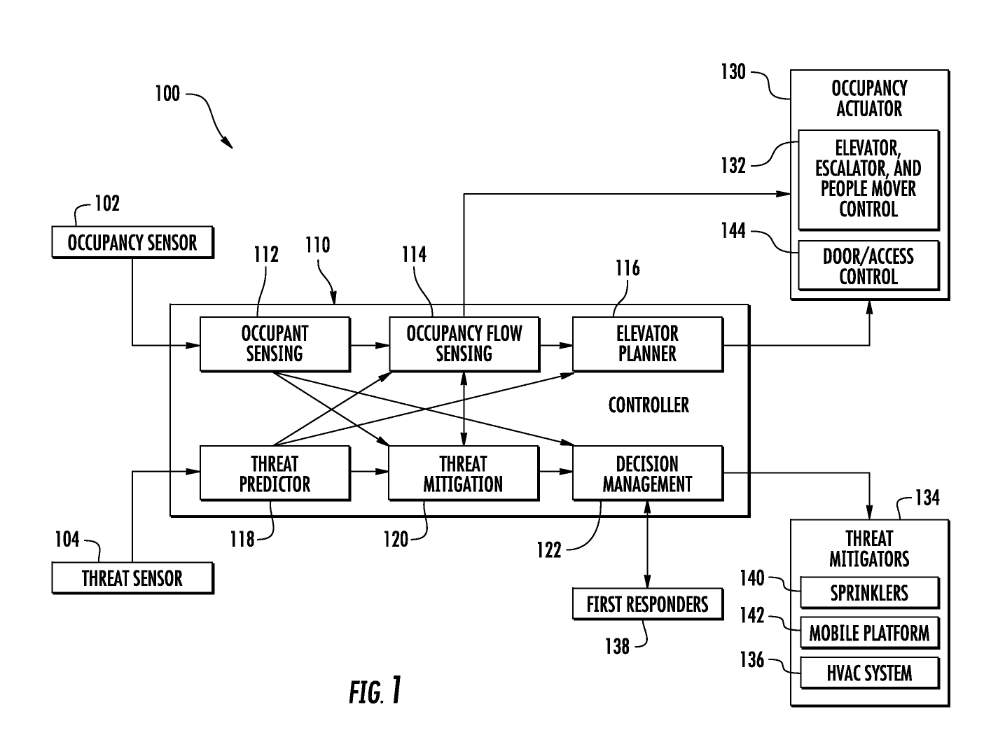

Referring to FIG. 1 an exemplary embodiment of building threat mitigation control system 100 is shown. In an exemplary embodiment, building threat mitigation control system 100 includes threat sensors 104, controller 110, and threat mitigators 134. In an exemplary embodiment, building threat mitigation control system 100 can provide active threat mitigation in response to one or more threats associated with a building. In an exemplary embodiment, system 100 provides real time decision control utilizing parameters received from occupancy sensors 102 and threat sensors 104.

In an exemplary embodiment, system 100 includes threat sensors 104. In certain embodiments, threat sensors 104 are deployable sensors mounted on mobile platforms, such as robots, that can be deployed as needed. Threat sensors 104 can include, but are not limited to, a general threat trigger, a smoke detector, a heat detector, a chemical sensor, a biological sensor, a radiation sensor, an acoustic sensor, a seismic sensor, etc. Threat sensors 104 can provide threat parameters to controller 110. Threat parameters can include, but are not limited to, a threat type, a threat scope, a threat propagation, a fused result from multiple threat sensors, and a threat pattern. In certain embodiments, data from threat sensors 104 and occupancy sensors 102 can be combined to form data with increased accuracy. Further, in certain embodiments, threat sensors 104 can be defined and categorized by local zones of a building.

In certain embodiments, system 100 includes occupancy sensors 102. In certain embodiments, occupancy sensors 102 are deployable sensors mounted on mobile platforms, such as robots, that can be deployed to locations as needed. Occupancy sensors 102 can include, but are not limited to, single, array, or distributed sensors sensitive to electromagnetic radiation, e.g., visible or infrared image or video cameras, stereo cameras, passive infrared motion sensors (PIR), pyroelectric sensors, radio-frequency identification (RFID) tags, and radar, heartbeat or breathing sensors; single, array, or distributed sensors sensitive to pressure variation, e.g., microphones; combinations of active transmitters and passive sensors, e.g., LIDAR, structured light depth sensors, and Time of Flight depth sensors; mechanically actuated sensors, e.g., switches, piezoelectric sensors, fiber optic strain sensors, vibration sensors, and micro electromechanical systems (MEMS); combinations of these sensors, etc. Occupancy sensors 102 can provide occupancy parameters to controller 110. Occupancy parameters can include, but are not limited to, an occupant count, an occupant location, an occupant flow pattern, an occupant mobility level, a building layout, etc. In certain embodiments, data from occupancy sensors 102 and threat sensors 104 can be combined to form data with increased accuracy or utility. Further, in certain embodiments, occupancy sensors 102 can be defined and categorized by local zones of a building.

In an exemplary embodiment, controller 110 provides real-time control of building functions. Advantageously, controller 110 may provide emergency and threat responses based on numerous parameters, including sensed parameters, known parameters, and extrapolations thereof. Known parameters can include building design, such as design of stairways and corridors, location of door access control devices, number and sizing of elevators, escalators, and other people movers, floors served by elevators, escalators, and people movers, location of occupancy sensors 102, location of threat sensors 104, etc. In an exemplary embodiment, controller 110 models emergency events and evacuation scenarios utilizing real time modeling possibly with reduced-order models. In certain embodiments, controller 110 can utilize predictive models, by first determining an objective and optimizing control strategies accordingly. In an exemplary embodiment, such strategies can be dynamically altered and updated (e.g., updating a strategy in response to a blockage of a path, evolution of a threat, or movement of people).

In an exemplary embodiment, controller 110 can reduce or minimize the total risk to building occupants by actively mitigating risks. Further, controller 110 can further reduce risk to first responders and property. In an exemplary embodiment, controller 110 can identify portions of the building as zones to determine emergency strategies. Zones may include, but are not limited to a floor in the case of a small-footprint tall building, but could be a subset of floor in a large-footprint building; closed stairwells would comprise separate zones, etc. Controller 110 can utilize a risk model to evaluate the risk in each zone of the building (e.g., risk is high in a zone where many heat and smoke sensors are activated, or a fire and smoke model indicates the risk based on the sensors) and generating a risk measure based on the number of occupants and the amount of time they spend in each zone. In certain embodiments, the risk-based strategy prioritizes egress from high-risk areas. Advantageously, the result of a risk-based strategy might be a targeted active mitigation of prioritized threats to significantly reduce the total risk.

In an exemplary embodiment, controller 110 includes threat predictor module 118 to utilize inputs from threat sensors 104 to determine and predict threats and threat propagation. For example, threat predictor module 118 can determine and predict the presence of smoke and predict smoke build up.

Advantageously, threat predictor module 118 can utilize a sensor fusion module to receive inputs from a plurality of sensors, such as occupancy sensors 102 and threat sensors 104 to obtain a cohesive set of parameters. Threat predictor module 118 can infer conditions based on such sensor data.

In an exemplary embodiment, threat predictor module 118 can account for the threat as it evolves over time via a threat propagation model. In certain embodiments, threat prediction models allow the controller 110 to preemptively prioritize mitigating threats and evacuating certain zones before imminent and emerging threats may put occupants in danger. These models may include combustion models in the case of fire, air flow dynamics based on temperature, stack effect, outside wind pressure, status of door opening, etc. In certain embodiments, the threat predictor model may track and predict the movement of an active shooter within the building.

In an exemplary embodiment, controller 110 utilizes threat mitigation module 120 to provide active mitigation to threats within the building. For example, threat mitigation module 120 can control threat mitigators 134 to reduce threats directly. In certain embodiments, threat mitigation module 120 can control threat mitigators 134 to remove smoke, close doors to control air flow, lock doors in an active shooter situation, pre sprinkle high fire risk areas, etc.

In an exemplary embodiment, threat mitigation module 120 identifies an optimal threat mitigation plan based on the propagation assessment via the threat predictor module 118. In certain embodiments, threat mitigation module 120 utilizes building information such as available equipment and equipment capability (e.g. max pressurization achieved in a particular zone by HVAC, ability to deploy fire suppressant without contaminating adjacent zones/ducts) to determine an optimal response.

Threat mitigation module 120 can utilize a combination of sophisticated algorithms, heuristic rules, list of a-priori defined action plans for certain threats, etc. in response to threats. In an exemplary embodiment, threat mitigation module 120 can utilize threat mitigators 134 to deploy the selected threat mitigation plan (e.g. supply effective suppressant via sprinkler in the fire zone, pressurize the adjacent two zones with HVAC, provide evacuation direction to occupants).

In certain embodiments, threat mitigation module 120 can monitor the progress and effectiveness of the threat mitigation via input sensors such as occupancy sensors 102 and threat sensors 104. Further, threat mitigation module 120 may make real time changes based on the progressing situation. In certain embodiments, threat mitigation module 120 can provide relevant information to the occupancy flow planner 114 to allow for evacuations to proceed accordingly.

In certain embodiments, decision management module 122 can facilitate analysis, evaluation, and execution of threat mitigation and evacuation strategies. In certain embodiments, decision management module 122 can facilitate communication with first responders that may be present or en route to the building. Decision management module 122 can further provide for remote management of controller 110 and associated building systems by authorized personnel.

In an exemplary embodiment, the decision management module 122 provides recommendations to an operations commander or other suitable decision maker to supplement or replace autonomous deployment of evacuation and threat mitigation strategies. Advantageously, recommendations provided by decision management module 122 can be reviewed by appropriate personnel. In an exemplary embodiment, any level of autonomy may be employed, as codes and practices will vary geographically and over time. Thus, embodiments may operate autonomously without human interaction or provide information for human decision making.

In certain embodiments, decision management module 122 continuously monitors sensor data to monitor the threat as it evolves (e.g., fire spreads to another floor) to determine if prioritization of threat mitigation and/or evacuation should change. In certain embodiments, decision management module 122 continuously monitors egress pathways for congestion and flow, to determine if egress routing should be adjusted. In certain embodiments, as first responders request or release resources such as elevators, decision management module 122 and controller 110 can adapt to best deploy all available resources.

Advantageously, the use of decision management module 122 is not only to handle situations that evolve over time, but also to make system 100 more robust to inaccuracies in the predictive models. For example, the threat predictor module 118 might not correctly account for limited fire suppression capabilities, which may slow down fire threat mitigation and increase smoke propagation. In such a case, decision management module 122 may dynamically observe the reduced fire suppression and deploy additional resources.

In certain embodiments, controller 110 can send and receive information from first responders 138 such as current occupant status and threat status. In certain embodiments, controller 110 can communicate information with first responders 138 via decision management module 122. First responders 138 can send and receive information to and from information servers that provide status information via mass notification systems, installed signage, and mobile devices. Decision management module 122 may provide access to offsite analysts (e.g., experts in a call center who can see live video feeds and assist first responders or provide additional data to the controller 110). First responders 138 can receive building control authority (e.g. elevator access) or other suitable access as required.

In an exemplary embodiment, controller 110 includes an occupant sensing module 112. In an exemplary embodiment, occupant sensing module 112 can determine and interpret parameters regarding building occupants via occupancy sensors 102 and/or threat sensors 104. Occupant sensing module 112 can determine and process occupant parameters, including, but not limited to occupant locations, occupant mobility levels, occupant flow patterns, occupant flow predictions, etc. In certain embodiments, occupant sensing module 112 can provide a model of occupant locations and occupant flow predictions.

In an exemplary embodiment, occupancy flow planner 114 utilizes the output from occupant sensing module 112 to determine occupant flow strategies in response to emergency events or other events. In an exemplary embodiment, occupancy flow planner 114 determines occupant flow strategies to flow occupants out of a building or into refuge areas. Occupancy flow planner 114 can utilize people flow models that predict the flow rate in all possible egress paths, such as corridors, stairways, doorways, elevators, escalators, etc.

For example, occupancy flow planner 114 can determine optimal elevator floor selection to minimize impact on risk exposure time or other factors. In certain embodiments occupancy flow planner 114 can utilize models for human behavior under stress, such as compliance with instructions, etc. In certain embodiments, occupancy flow planner 114 can utilize predictive models of building equipment to predict performance of building equipment for metrics such as people moving (elevator and escalator throughput) and controlling air flow for attenuating airborne risks such as smoke and contaminants.

Advantageously, the use of real-time, predictive models allows controller 110 to determine an egress strategy that is adaptable to actual conditions rather than a fixed strategy that may have been optimized for a single condition. With predictive models, alternative strategies can be evaluated to select an optimal strategy. In certain embodiments, advanced methods such as model predictive control (MPC) and optimization-based control (OBC) are employed. In certain embodiments, pathway risk measures along a number of possible pathways can be evaluated until an optimal evacuation plan is determined.

In certain embodiments, occupancy flow planner 114 directs occupants to refuge spaces instead of, or in addition to, exiting a building. A refuge space in a building may be an area with protection from spread of fire, special facilities, alternative air supply, emergency power, etc. In certain embodiments, occupancy flow planner 114 can determine suitable refuge areas for evacuation purposes.

In an exemplary embodiment, elevator planner 116 determines optimal elevator use in accordance with strategies created by occupancy flow planner 114. In an exemplary embodiment, elevator planner 116 can determine if elevator use is permissible, and further determine optimal combined stairway and elevator approaches.

Elevator planner 116 can evaluate operating conditions and threats relevant to elevator operation (e.g. fire; chemical, biological, or radiological, agents; or smoke near points of elevator entry/egress) to determine if elevator assisted evacuation is possible or recommended.

In certain embodiments, elevator planner 116 can utilize load balancing methods to optimize elevator use. For example, elevator planner 116 may utilize elevators to serve a small number of floors and to have occupants not on those floors take the stairs to the served floors to optimize elevator operations. Advantageously, elevator planner 116 can balance the load on the principal bottlenecks (e.g., stairs and elevators). In certain embodiments, elevator planner 116 can utilize risk measure values to determine optimal elevator planning. Elevator planner 116 can determine risk measure value by the time spent at each location in the building multiplied by the risk measure value at that location, summed separately for each evacuee over their evacuation path to minimize such a value.

In an exemplary embodiment, threat mitigators 134 can be controlled by threat mitigation module 120 to actively mitigate threats that may exist in the building. Threat mitigators 134 can include, but are not limited to a pre-sprinkling device, a battery discharge device, a fire suppression coating device, an inert gas release device, a controlled burn device, a robotic device, a filtration device, a door control, etc.

In certain embodiments, HVAC system 136 is utilized as a threat mitigator 134. In certain embodiments, HVAC system 136 threat mitigation strategies include, but are not limited to supplying threat suppressant via HVAC system 136 (e.g., supply air ducts) in the threat zone, adjacent zones, and evacuation path to minimize the spread of threat, such as fire. Other embodiments include utilizing HVAC system 136 to provide a flow of suppressant can be controlled/directed to specific zones (e.g., rooms) using dampers available in supply ducts. Further, HVAC system 136 can also be used for pressurizing the evacuation route. Advantageously, this allows the evacuation route to remain free of harmful substances such as smoke, chemical fumes, and biological agents. In another embodiment, HVAC system 136 engages HVAC dampers to control return air flow from threat locations.

In certain embodiments, in conjunction with HVAC system 136, HVAC system can include filters to be utilized as a threat mitigator 134. In certain embodiments, filters can be used in select areas to absorb airborne threats, such as smoke, chemical fumes, and airborne biological or radiological agents. In certain embodiments, filters will also reduce the pressure gradient between a fire zone and outside the building, which may reduce the rate of fume exhaust to outside the zone.

In certain embodiments, building sprinklers 140 can be utilized as threat mitigators 134. In certain embodiments, the threat zone, adjacent zones, and evacuation path can be pre-conditioned by building sprinklers (e.g., pre-sprinkled with water, cool the zone below a set-point) to reduce threat spread and potentially improve comfort during evacuation. In certain embodiments, threat suppressants can be also delivered with sprinkler system.

In certain embodiments, threat mitigator 134 can include a threat suppressant system. In certain embodiments, the threat suppressant system can deploy suitable suppressants contingent on the presence of occupants as directed by threat mitigation system 120. If there are no occupants in a certain area, a more aggressive suppression strategy can be used. Alternatively, if occupants are detected in a certain area, a suppressant safe for the occupants is deployed. For example, an aggressive fire suppressant includes those that are typically not considered safe for humans but are very effective in controlling threats, such as CO2 in the case of fire. A safe suppressant is the one that is acceptable in the presence of humans, such as Halon or water in the case of fire. In certain embodiments, threat suppressants can be delivered via at least one of sprinkler systems, ducted HVAC systems, manual delivery, robot assisted delivery, wall mounted cylinders, etc.

In certain embodiments, access control devices can be utilized as a threat mitigator 134. In certain embodiments, an access control system prevents any occupant from entering the zone that is being delivered an aggressive suppressant. Access control devices may lock all entry points to this zone and revoke/suspend all occupant credentials. Access control devices may provide special access to first responders.

In certain embodiments, threat mitigators 134 can include devices to reduce combustion risk. Generally certain threat mitigators 134 protect or eliminate any combustible items that can support threat propagation, (e.g. discharge lithium ion batteries to prevent explosion under fire, coat combustible items with fire suppressant materials, surround combustible material with inert gas, create a controlled burn in case of fire, etc.). In certain embodiments, HVAC system 136 can be utilized to provide pressurization to prevent any secondary damage from controlled burn procedures.

In certain embodiments, threat mitigator 134 can include a mobile notification and mitigation platform 142. In certain embodiments, the mobile platform can be used to implement, trigger, or deploy any of the above threat mitigation strategies, e.g. spray suppressant in an evacuation path, guide occupants along an egress path, or create controlled burn.

In certain embodiments, threat mitigator 134 can prevent collateral damage to the building from other suppression methods. In certain embodiments, channels can be designed near elevator doors on each floor to divert water and prevent it from entering the elevator system. In certain embodiments, such diverted water can be stored in a reservoir to be reused for fire suppression.

In an exemplary embodiment, controller 110 utilizes occupancy actuators 130 to control the flow of occupants within the building in accordance with occupancy flow planner 114. Advantageously, occupancy actuators 130 can direct occupants to desired locations such as optimal exit paths or paths to refuge zones as determined by occupancy flow planner 114. In an exemplary embodiment, occupancy actuators 130 can include, but are not limited to a display, a light output, a mobile communication device notification, audio announcement device, a mobile platform to guide occupants, and a door access control. In certain embodiments, occupancy actuator 130 can utilize elevator, escalator, and people mover control 132 to control the flow of occupants therein. In other embodiments, occupancy actuator 130 can utilize door/access control 144 to control the movement of occupants therein.

In an exemplary embodiment, system 100 can utilize elevator, escalator, and people mover control 132 as an occupancy actuator 130. Elevator, escalator, and people mover control 132 can receive inputs from elevator planner 116 to determine a safe and optimal operation of elevators during emergency events. Similarly, occupancy actuator 130 may control escalators, people movers, etc. to control the flow of building occupants.

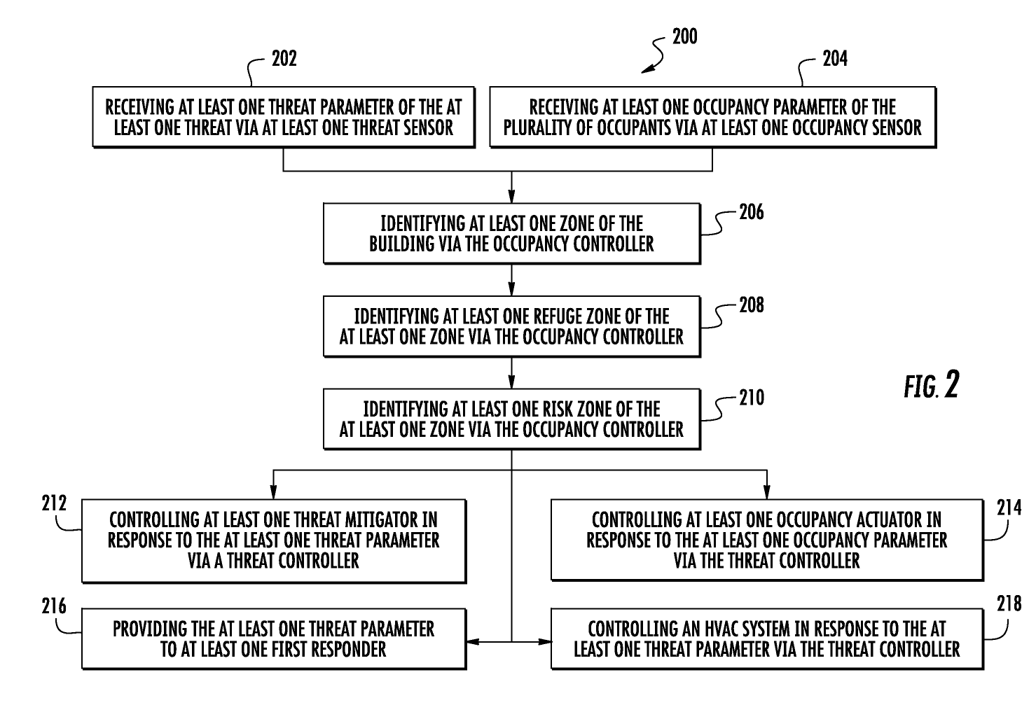

Referring to FIG. 2, a method 200 to mitigate threats associated with a building is shown. In an exemplary embodiment, method 200 can utilize system 100 described above to perform the method described herein. In operation 202, in an exemplary embodiment, at least one threat sensor within the building can provide at least one threat parameter. Threat sensors can include, but are not limited to, a general threat trigger, a smoke detector, a heat detector, etc. Threat parameters can include, but are not limited to, a threat type, a threat scope, a threat propagation, and a threat pattern.

In operation 204, at least one occupancy sensor receives at least one occupancy parameter regarding the plurality of occupants within the building. Occupancy sensors can be any suitable occupancy sensors to determine characteristics of the occupants within. Occupancy sensors can include, but are not limited to, single, array, or distributed sensors sensitive to electromagnetic radiation, e.g., visible or infrared image or video cameras, stereo cameras, passive infrared motion sensors (PIR), pyroelectric sensors, radio-frequency identification (RFID) tags, and radar, heartbeat or breathing sensors; single, array, or distributed sensors sensitive to pressure variation, e.g., microphones; combinations of active transmitters and passive sensors, e.g., LIDAR, structured light depth sensors, and Time of Flight depth sensors; mechanically actuated sensors, e.g., switches, piezoelectric sensors, fiber optic strain sensors, vibration sensors, and micro electromechanical systems (MEMS); and combinations of these sensors. Occupancy parameters can include, but are not limited to, an occupant count, an occupant location, an occupant flow pattern, an occupant mobility level, a building layout, etc.

In operation 206, the threat controller or main controller can identify zones within the building. Zones may include, but are not limited to a floor in the case of a small-footprint tall building, but could be a subset of floor in a large-footprint building; closed stairwells would comprise separate zones.

In operation 208, the threat controller or main controller may optionally identify a refuge zone of the previously identified zones. In certain embodiments, refuge space in a building may be an area with protection from spread of fire, special facilities, emergency power, etc. In certain embodiments, the controller can determine suitable refuge areas for evacuation purposes.

In operation 210, at least one risk zone of the previously identified zones is identified. In certain embodiments, the controller can utilize a risk model to evaluate the risk in each zone of the building (e.g., risk is high in a zone where many heat and smoke sensors are activated) and generating a risk measure based on the number of occupants and the amount of time they spend in each zone.

In operation 212, at least one threat mitigator is controlled via the threat controller in response to a threat parameter previously sensed. In certain embodiments, occupancy parameters are also considered via the threat controller. Threat mitigators can include, but are not limited to a pre-sprinkling device, a battery discharge device, a fire suppression coating device, an inert gas release device, a controlled burn device, a robotic device, a filtration device, etc. Threat mitigators can be actively engaged either automatically or manually reduce a threat for occupants, first responders, and the building.

In operation 214, at least one occupancy actuator is controlled in response to a threat parameter via the threat controller. In certain embodiments, an occupancy parameter are also considered via the threat controller. In an exemplary embodiment, occupancy actuators can include, but are not limited to a display, a light output, a mobile device notification, audio announcement device, and a door access control. In certain embodiments, occupancy actuators can utilize elevator control to control the flow of occupants therein. Advantageously, occupant flow can be controlled by the controller via the occupancy actuators to predetermined safe areas such as building exits and refuge areas in accordance with evacuation strategy determined by the controller.

In operation 216, the threat mitigation controller can provide at least one threat parameter to at least one first responder. In certain embodiments, the controller can provide relevant information regarding threats in the building, high risk zones, refuge zones, occupant locations, occupant special needs/requirements, etc.

In operation 218, a building HVAC system can be controlled by the threat controller or main controller in response to the occupancy parameters and any threat parameters. In certain embodiments, a building HVAC system can be used to mitigate threats such as smoke, chemical exposure, etc. Advantageously, HVAC systems can create zones of positive pressure to prevent smoke and chemicals in certain areas. In other embodiments, the HVAC systems can be utilized to distribute fire suppression chemicals, etc.

The terminology used herein is for the purpose of describing particular embodiments only and is not intended to be limiting of the embodiments. While the description of the present embodiments has been presented for purposes of illustration and description, it is not intended to be exhaustive or limited to the embodiments in the form disclosed. Many modifications, variations, alterations, substitutions or equivalent arrangement not hereto described will be apparent to those of ordinary skill in the art without departing from the scope and spirit of the embodiments. Additionally, while various embodiments have been described, it is to be understood that aspects may include only some of the described embodiments. Accordingly, the embodiments are not to be seen as limited by the foregoing description, but are only limited by the scope of the appended claims.

What is claimed is:

1. A method to mitigate at least one threat associated with a building, comprising:
receiving at least one threat parameter of the at least one threat via at least one threat sensor;
receiving at least one occupancy parameter of at least one occupant via at least one occupancy sensor; and
actively controlling at least one threat mitigator in response to the at least one threat parameter and the at least one occupancy parameter via a threat controller.

2. The method of claim 1, wherein the at least one threat sensor is selected from a group consisting of a manually activated threat trigger, a smoke detector, a heat detector, a chemical detector, a biological detector, a radiation detector, an acoustic detector, a seismic detector.

3. The method of claim 1,
wherein the at least one threat parameter is selected from a group consisting of: a threat type, a threat scope, a threat propagation, and a threat pattern.

4. The method of claim 1,
wherein the at least one threat mitigator is selected from a group consisting of: a sprinkling device, a battery discharge device, a fire suppression coating device, an inert gas release device, a suppressant delivery device, a controlled burn device, a robotic device, and a filtration device.

5. The method of claim 1, further comprising controlling an HVAC system in response to the at least one threat parameter via the threat controller.

6. The method of claim 1, further comprising providing the at least one threat parameter to at least one first responder.

7. The method of claim 1, further comprising identifying at least one zone of the building via the threat controller.

8. The method of claim 7, further comprising identifying at least one refuge zone of the at least one zone via the threat controller.

9. The method of claim 7, further comprising identifying at least one risk zone of the at least one zone via the threat controller.

10. The method of claim 1, further comprising:
controlling at least one occupancy actuator in response to the at least one occupancy parameter via the threat controller.

11. The method of claim 10, wherein the at least one occupancy sensor is selected from a group consisting of: a video camera, a stereo camera, a passive infrared motion sensor, a pyroelectric sensor, a radio-frequency identification (RFID) sensor, a radar, a heartbeat sensor, a breathing sensors, a microphone; a LIDAR, a structured light depth sensor, a Time of Flight depth sensor, a switch, a piezoelectric sensor, a fiber optic strain sensor, a vibration sensor, and a micro electromechanical system (MEMS).

12. The method of claim 10, wherein the at least one occupancy parameter is selected from a group consisting of: an occupant count, an occupant location, an occupant flow pattern, an occupant mobility level, and a building layout.

13. The method of claim 10, wherein the at least one occupancy actuator is selected from a group consisting of: a display, a light output, a mobile communication device notification, audio announcement device, a mobile platform, and a door access control.

14. The method of claim 10, wherein the at least one occupancy actuator is selected from a group further consisting of an elevator, escalator, or people mover control.

15. A building control system, comprising:
at least one threat sensor to receive at least one threat parameter;
at least one occupancy sensor to receive at least one occupancy parameter; and
a threat controller to control at least one threat mitigator in response to the at least one threat parameter and the at least one occupancy parameter.

16. The building control system of claim 15, wherein the at least one threat sensor is selected from a group consisting of manually activated threat trigger, a smoke detector, a heat detector, a chemical detector, a biological detector, a radiation detector, an acoustic detector, a seismic detector.

17. The building control system of claim 15, wherein the at least one threat parameter is selected from a group consisting of: a threat type, a threat scope, a threat propagation, and a threat pattern.

18. The building control system of claim 15, wherein the at least one threat mitigator is selected from a group consisting of: a sprinkling device, a battery discharge device, a fire suppression coating device, an inert gas release device, a suppressant delivery device, a controlled burn device, a robotic device, and a filtration device.

19. The building control system of claim 15, wherein the at least one threat mitigator is selected from the group further consisting of an HVAC system.

20. (canceled)
